(19) United States
(12) Patent Application Publication
(10) Pub. No.: US 2007/0074228 A1
(43) Pub. Date: Mar. 29, 2007

(54) Method, apparatus and computer programs for differential deserialization

(75) Inventors: Toyotaro Suzumura, Tokyo (JP); Toshiro Takase, Yamato-shi (JP); Michiaki Tatsubori, Yamoto-shi (JP)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 11/484,959

(22) Filed: Jul. 12, 2006

(30) Foreign Application Priority Data
Jul. 12, 2005 (GB) 0514192.4

(51) Int. Cl. G06F 9/46

(52) U.S. Cl. 719/330

(57) ABSTRACT

Provided are methods, apparatus and computer programs for optimized performance of Web services processing, using differential deserialization. The solution eliminates redundant processing by identifying similarities between SOAP messages or other Web services requests and reusing an 10 application object deserialized in the past.

### FIELD OF INVENTION

The present invention relates to data processing and in particular to processing service requests and other messages for which deserialization is required.

### BACKGROUND

Web services technology has emerged as a key infrastructure for enabling business entities to interact with each other without any human invention. Web services enable interoperability within a distributed, loosely coupled and heterogeneous computing environment. The Web services technology is built on SOAP as the messaging layer, WSDL as the interface description, and UDDI as the service discovery mechanism. Web services are expected to be a key building block for enabling next generation computing platforms such as Service Oriented Architectures and Grid computing.

Recent studies have investigated Web services performance issues, attempting to improve performance without compromising interoperability. The poor performance stems from the fact that Web services are based on the Simple Object Access Protocol (SOAP) using the extensible Markup Language(XML). SOAP provides the fundamental messaging infrastructure supporting XML document exchange and Remote Procedure Calls using XML messages, but its redundant characteristics and its textual representation have resulted in major performance limitations.

The inventors of the present invention have recognized that, although it is not straightforward to optimize XML processing in a general manner, optimization can be achieved by making use of characteristics of a specific problem domain. In a typical Web services solution, most messages are generated by machines and, particularly in the case of RPC-style request-response messages, are often generated by middleware with XML serializers. When accessing Web services in client code, proxy classes and frameworks provided by middleware handle much of the processing. Though formatting styles are different for various programming languages, implementation vendors, or versions, the same XML serializer implementation generates the same kind of service requests and responses, with different parameters and return-values in similar byte sequences. This is because such XML serialization is typically performed by a certain runtime library or proxy code generated by a certain tool provided by middleware or a development environment.

T. Takase, H. Miyashita, T. Suzumura and M. Tatsubori, “An Adaptive, Fast, and Safe XML Parser Based on Byte Sequences Memorization”, Proceedings of the 14^{th} International World Wide Web Conference (WWW 2005), pages 692-701, May 10-14, 2005, Chiba, Japan, describes improving the performance of an XML parser based on the fundamental characteristics of Web services. The XML parser detects the differences between a new XML message and previously-received messages, and performs semantic parsing only for the different portion. When processing a new XML document in a byte sequence, the parser remembers the byte sequences in a DFA (Deterministic Finite Automaton), where each state transition has a part of the byte sequence and its resultant parse event. In addition, the parser remembers processing contexts in DFA states so that it can partially parse the unmatched byte sequence until it meets a resultant state from which it can transit to existing states.

Deserialization is a process of converting messages to application objects that can be passed to application logic for processing. The deserialization involves a series of tasks such as fetching an appropriate deserializer from a registry (using type mappings), and constructing a Java object from 20 an XML message. The cost of object creation increases for increasingly complex objects and a deeper object tree. Although deserialization overheads are significant in a Web services environment, known attempts to improve Web services performance have not specifically focussed on optimizing deserialization.

### SUMMARY

Aspects of the present invention provide methods, apparatus and computer programs for optimizing performance of Web services processing, using differential deserialization. The solution eliminates redundant processing by identifying similarities between SOAP messages or other Web services requests and reusing an application object deserialized in the past. Deserialization is performed only for the part of a message that differs from a previously processed message.

The present invention avoids much of the processing overhead of deserialization, by only processing the parts of an XML message that differ from previously-processed messages, and reusing an object resulting from a previous deserialization.

### BRIEF DESCRIPTION OF DRAWINGS

Embodiments of the invention are described below in more detail, by way of example, with reference to the accompanying drawings in which:

FIG. 1 is a schematic representation of a solution architecture for differential deserialization;

FIG. 2 shows an example SOAP message;

FIG. 3 represents a deserialization automaton;

FIG. 4 is a schematic representation of the steps of a method according to an embodiment of the invention.

### DESCRIPTION OF EMBODIMENTS

As an implementation example for optimized deserialization according to the invention, a deserialization mechanism for the Java API for XML-based remote procedure calls (JAX-RPC) is described below. In this example environment, an XML serializer at a client system serializes an object and sends the serialized result as an XML string to an application server.

Deserialization is the process of reconstructing an object from XML data. The object is serialized for transmission, and then parsed and deserialized by a SOAP engine at the receiver system to enable processing by an application or service. The serialization and deserialization mechanisms in JAX-RPC rely on the availability of a type-mapping system defined in a registry. When the SOAP engine reads a particular piece of XML and comes across a given element of a given schema type, the SOAP engine can locate an appropriate deserializer in order to convert the XML into Java. The SOAP engine usually has a registry where a set of required type mappings are registered. JAX-RPC introduces a layer called TypeMapping and TypeMappingRegistry contains multiple TypeMappings, and then the TypeMappings enable mapping between XML and Java types.

Deserializing an XML message into Java objects involves the following steps:
1. Open the XML element that represents the object;
2. Recursively deserialize each of the object's members which are encoded as sub-elements after locating an appropriate deserializer from a type mapping system;
3. Create a new instance of the Java type, initializing it with the deserialized members; and
4. Return the new object.

Even though serialization and deserialization are symmetric functions, different issues need to be solved for optimizing deserialization compared with serialization, because the reused object is different. In a serialization process, the XML message is a target for recycling. In the deserialization process, the target is an application object and it is not possible to simply reuse the object because there could be situations in 5 which the object is modified by applications. A simple reuse of an application object may avoid redundant processing but cannot be expected to avoid undesirable side-effects.

Described below are a solution architecture and method for increasing SOAP performance.

1. Differential Parser

T. Takase, H. Miyashita, T. Suzumura and M. Tatsubori, “An Adaptive, Fast, and Safe XML Parser Based on Byte Sequences Memorization”, Proceedings of the 14ₜₕ International World Wide Web Conference (WWW 2005), pages 692-701, May 10-14, 2005, Chiba, Japan, is incorporated herein by reference. The referenced article describes a mechanism for efficiently processing XML documents for most XML usages. Given a new XML document in a byte sequence, the XML parser avoids analysing most of the XML syntax in the document by comparing the byte sequence with sequences that were previously processed. The parser then reuses the resultant parse events stored in previous processing. Only the differential parts from the previously-processed documents are processed in a normal manner for XML parsing. The parser remembers the byte sequences in a DFA (Deterministic Finite Automaton), where each state transition has a part of byte sequence and its resultant parse event. In addition, the parser remembers processing contexts in DFA states to enable partial parsing of the unmatched byte sequence until the parser meets a resultant state from which it can transit to existing states. Then the parser proceeds to transit in the DFA.

The differential deserialization described below is complementary to the differential parsing solution described in the above-referenced article. In combination, differential parsing and differential deserialization can 35 avoid significant processing overheads for input sequences that match previously processed sequences.

2. Differential Deserialization

In a Web services architecture, the processing required for XML parsing and deserialization are significant but can be reduced significantly using the solution described herein.

The solution deserializes only the part of an XML message that has not been processed in the past, recycles an application object deserialized during earlier processing of a similar message, and resets the fields in the object. This approach is referred to herein as “differential deserialization” and can eliminate a series of processes normally required for the completion of deserialization. In particular, eliminating object creation provides a significant saving of required processing because objects are expensive to create. Objects need to be created before they can be used and garbage-collected when they are finished with. The more objects you use, the more costly this recycling and garbage-collection becomes.

Object recycling is known in other contexts for performance-tuning, especially for objects that are constantly used and discarded. Recycling can also apply to the internal elements of structures. The differential 15 deserialization method described herein applies object recycling to deserialization.

3. Architecture Design

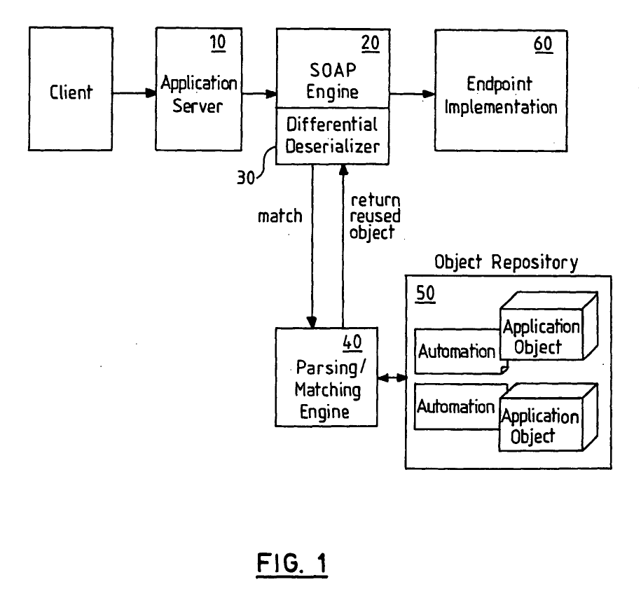

FIG. 1 shows an overview of an architecture for differential deserialization. The architecture is comprised of the following components: a Servlet Engine 10, a SOAP engine 20, a Differential Deserializer 30, an Endpoint implementation 60, a Matching and Parsing Engine 40, and an Object Repository 50.

This architecture differs from a conventional Web services architecture only in that the deserializer is replaced with a differential deserializer. The differential deserializer 30 is a component that communicates with a Matching and Parsing Engine 40, which together provide all of the functionality required for differential deserialization. The differential deserializer component 30 performs two main functions:
to dynamically generate an automaton from the incoming XML messages and then, after deserializing into the application object by the SOAP engine in a normal way, to make a link between the defined automaton and the application object; and
to match an incoming message with the existing set of automaton paths and, if matched, to return the linked application object to the SOAP engine after partially deserializing only the region that differs from previously-processed messages, and then resetting the fields. 3.1 Creating
   3.1 Creating New Deserialization Automaton

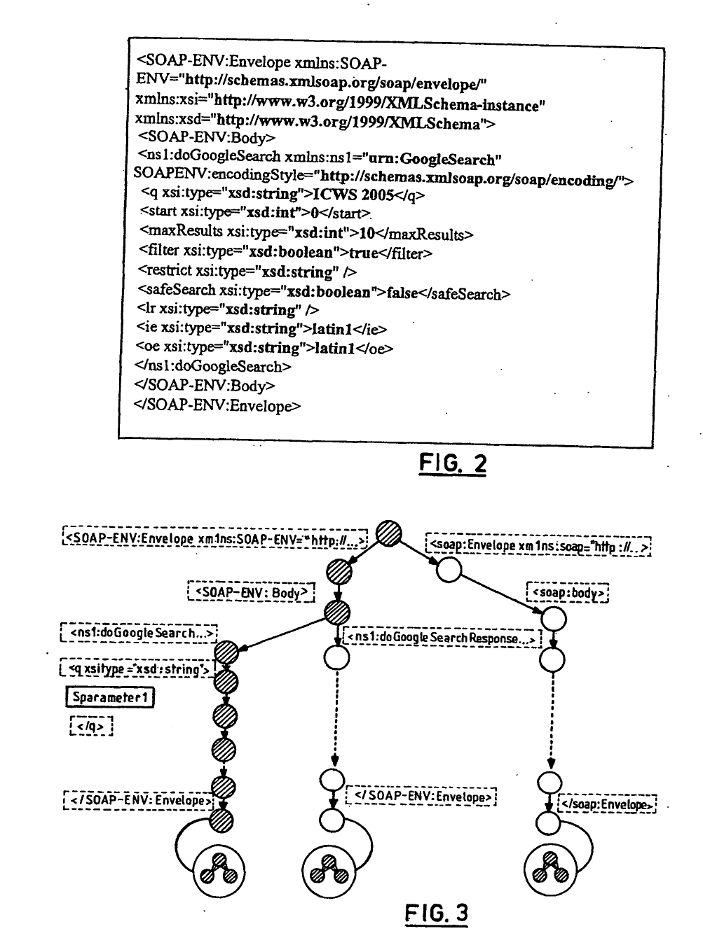

At a time when the SOAP engine receives a brand new message, the Matching Engine creates a new automaton path (referred to hereafter as the deserialization automaton), after the deserialization component in the SOAP engine generates the application object in a normal way. For instance, when dealing with a new SOAP message such as shown in FIG. 2, the Matching Engine detects that there is no matched state transition by byte-sequence matching, and then starts to create a new deserialization automaton. FIG. 3 shows a sample of the deserialization automaton and a series of state nodes (black nodes represent the newly created deserialization automaton). After reaching up to the final state (</SOAP-Envelope>), the Matching Engine make a link from the final state to the corresponding application 10 object.

Note that a deserialization automaton consists of two states: fixed state and variable state. A fixed state is literally a state whose byte sequence is not changed such as a start tag (e.g. <SOAP-Env:Body>), an end tag (e.g. </SOAP-Env:Body>) , and some text content that is defined as a constant value in the XML Schema. Meanwhile, a variable state is a state whose byte sequence can vary in messages. For example, the part between a start tag <g> and an end tag </g> is variable and should be represented as a variable state.

In the solution described herein, a variable state is determined by checking a set of RPC (Remote Procedure Call) parameters defined in a SOAP envelope. The SOAP envelope object allows programmers to access the information with regard to what RPC parameters should be passed for certain SOAP operations and their data type. While creating a new deserialization automaton, the Matching engine collects information for variable states and creates a table called “Variable Table” for maintaining them. This table is used for updating the fields with new values when reusing the application object. Each record in the table contains the following information:
1. Variable ID: a key that identifies the variable object
2. Object parent: a target object that a new value of the variable object should be set to.
3. Class type: a data type of the variable object
4. Object value: a new value of the variable object
5. (Optional) Method setter: a setter method of the parent object that updates the new value.

The last item above is optional because it is possible to obtain a setter method for updating the value by investigating the parent object with the Java reflection APIs, although it is more straightforward to preserve the setter method object.

Finally, after the Matching Engine creates the corresponding Variable Table, the engine also attaches the table with the final state of the deserialization automaton along with the application object.

3.2 Object Recycling and Differential Deserialization

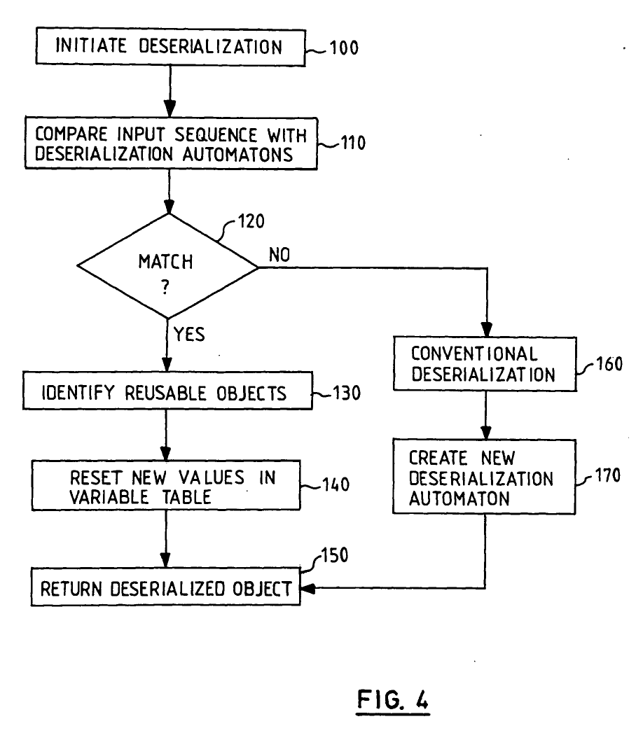

FIG. 4 shows method steps performed when processing an input sequence, according to the differential deserialization solution. The figure starts with initiation 100 of deserialization. When the matching engine processes a message that is similar to a previously processed message, the engine traverses 110 the existing deserialization automaton to identify a match 120. When going through the variable state, the byte sequence up to the next state is partially parsed and deserialized by the SOAP engine. Then the engine updates the new value in the Variable Table using the Variable ID. Finally, if the engine reaches up to the existing final state after traversing the deserialization automaton, the matching engine determines 130 that the engine can reuse the application object and resets 140 a set of new values specified in the Variable Table. The resulting object is then returned 150 as the deserialization result. However, if traversing paths corresponding to existing stored deserialization automatons fails to identify a match, the processing reverts to conventional deserialization 160 followed by creation 170 of a new deserialization automaton.

Various approaches are possible for reusing the application object, and an optimal implementation can be selected according to the complexity of the object and how the object is accessed by the application, as described below. A solution for resetting values is also described below.

4. Reusing Application Objects

Two alternative approaches for reusing application objects are (1) reusing a reference to the application object and/or (2) using the object that is replicated from the application object. The first approach is relatively straightforward as well as relatively fast, but may not be widely available. The limitation on availability is that a business object is read-only except for the primitive value such as String and Integer. The second approach is slower but is safe and applied to various situations. The simple way to implement the second approach is to clone the entire object tree, but there are scenarios in which a certain part is fixed and the structure would not change at all. The inventors of the present invention have determined that it would be significantly more effective to store only the portions of application objects that corresponds to the changed portion (and, at least in some embodiments, to dynamically adjust the granularity at which business objects can be reused)

The following approaches can be used for reusing the application object:

4.1 No copying

In a case that guarantees that the object is read-only and the endpoint 5 implementation does not change the object, a reference to the application object can be reused without any copying.

4.2 Copying by Cloning

If the application object does not override the clone method of the Object class, calling a clone method of the object performs only shallow copy. In this case, if all of the fields of the application object are immutable types, the clone method is adequate to avoid side effects. If some mutable fields exist in the application object, the shallow copy is not enough. If some mutable fields exist, a deep copy method recursively copies the object tree. Currently, the Java classes generated by a known WSDL compiler do not implement the clone method, so a clone method is added to perform the deep copying.

4.3 Copying by the Java Serialization Method

Java serialization enables the target object and all of its fields to be serialized into a byte array, except for transient fields. Also the objects referred to by its fields are serialized recursively. In Java deserialization, another new object of the same type and having the same value is reconstructed from the serialized byte array. That is to say, we can copy the object deeply using Java serialization and deserialization. The Java serialization is only available when the application object implements the Java.io.Serializable interface, but note that the generated classes by WSDL2Java implements the interface.

4.4 Copying by Using the Java Reflection API:

This approach performs a deep copy method by using the Java reflection API. The method can deeply copy bean-type and array-type objects. With this approach, application developers need not implement the clone method like the second approach.

5. Setting New Values

Two possible ways to reset the fields of an application object with new values are:
i. to use the reflection API : By searching for the appropriate method for setting the new value for the target object with the Java reflection API.
ii. to preserve the parent object and a method: To avoid the searching cost in the above method, we can merely store the method object when creating a new automaton state node.

1. A method for deserializing an input sequence, received by a data processing apparatus within a data processing network, to create an object for processing, the method comprising:
storing a set of elements of a first input sequence in association with a deserialized object;
comparing a second input sequence with the stored set of elements to identify a match, and to identify portions of the second input string that differ from the stored set of elements;
in response to identification of a match, retrieving the stored associated deserialized object;
in response to identification of portions of the second input string that differ from the stored set of elements, deserializing the identified portions; and
resetting fields of the retrieved deserialized object with the results of deserializing the identified portions.

2. A data processing apparatus comprising:
a matching engine for performing the steps of:
storing a set of elements of a first input sequence in association with a deserialized object, and for comparing a second input sequence with the stored set of elements to identify a match and to identify portions of the second input string that differ from the stored set of elements; and
a differential deserializer for performing the steps of:
in response to identification of a match, retrieving the stored associated deserialized object;
in response to identification of portions of the second input string that differ from the stored set of elements, deserializing the identified portions;
and resetting fields of the retrieved deserialized object with the results of deserializing the identified portions.

3. A computer program comprising program code for controlling a data 40 processing apparatus to perform a method according to claim 1.
